(19) United States
(12) Patent Application Publication
(10) Pub. No.: US 2024/0348135 A1
(43) Pub. Date: Oct. 17, 2024

(54) Electric motor, method for assembling said motor, and automotive vehicle comprising such a motor

(71) Applicant: Yuyao Actuator Electric Motor Co., Ltd, Yuyao City (CN)

(72) Inventor: Antoine TESTASECCA, LES HERBIERS (FR)

(21) Appl. No.: 18/683,293

(22) PCT Filed: Aug. 9, 2022
(86) PCT No.: PCT/CN2022/111074

§ 371 Date: Feb. 13, 2024

(30) Foreign Application Priority Data
Aug. 13, 2021 (CN) 2021109307091

(51) Int. Cl. H02K 15/12; H02K 5/10; H02K 15/14

(52) U.S. Cl. CPC H02K 15/12; H02K 5/10; H02K 15/14

(57) ABSTRACT

“A method is provided for assembling a motor having an enclosure 6 with a body 7 and a cover 8, electric cables for connecting the motor forming a bundle 10 of cables, the cover 8 being provided with a housing 9 for receiving a sleeve 13 for retaining the bundle 10 of cables. The method includes: a step of overmoulding of the sleeve 13 over the bundle 10 of cables; a step of assembly of the cover 8 on the body 7 during which the cover 8 is threaded onto the bundle 10 of cables; a step of extraction of the sleeve 13 out of the enclosure 6; a step of positioning of seals 19 on the sleeve 13; a step of insertion of the sleeve 13 into the housing 9; and a step of fixing into relative position of the sleeve 13 by means of a flange 16.

### TECHNICAL FIELD

The present invention relates to a method for assembling an electric motor, an electric motor that can be assembled according to this method and an automotive vehicle bearing at least one such electric motor, in particular for a grass-cutting application, notably mowing.

### BACKGROUND

It relates in particular to a method for assembly a motor comprising a rotor, a stator, an enclosure with a body and a cover for at least partially enclosing the rotor and the stator, electric cables connecting the motor forming a bundle of mutually independent cables, connected to the motor, said enclosure being provided with a housing for receiving a sleeve for retaining the bundle of cables formed in the cover or the body of the enclosure, this through cylindrical housing having an open end facing the inside of the enclosure and an open end facing the outside of the enclosure.

To ensure the mowing of a lawn or of a space reserved for a sport practiced on grass, it is common practice to use an automotive vehicle equipped with cutting blades driven by an electric motor. Such a motor is preferably three-phase, housed in an enclosure, and powered by means of several cables passing through an opening in the enclosure. It is also common practice to place sensors in the motor and to link them, outside the enclosure, to a monitoring device. In such a situation, mutually independent cables, often of different diameters, have to be connected inside the enclosure and linked to the outside of the enclosure. These cables constitute a heterogeneous bundle which passes through the opening of the enclosure of the motor.

To ensure the sealing of the enclosure, it is known practice to use an insulating collar surrounding the bundle of cables. The effectiveness of such a collar is relative to the extent that the space between the cables of the bundle is not blocked. Moreover, such a collar cannot ensure the securing of all the cables of the bundle if one or more cables are inadvertently pulled.

The document CN21 1126951 describes a sleeve to be placed in the opening of the enclosure of the motor. This sleeve comprises longitudinal holes for the passage of the motor power supply cables. The cables must be introduced individually into the holes, which constitutes a lengthy and difficult operation. Furthermore, the cables slide in the holes and are not firmly retained in the event of inadvertent pulling.

One technical problem to be resolved is to make the motor watertight and airtight, and to ensure that each cable of the bundle of the cables linked to the motor cannot be torn out.

One of the aims of the invention is to produce the sealing of the enclosure of the electric motor by means of a sleeve that simultaneously ensures the individual retention of the cables.

Another aim of the invention is to perform the assembly of an electric motor linked to the outside by a bundle of cables, by means of a simple and safe method.

### SUMMARY

To this end, the subject of the invention is a method for assembling a motor comprising a rotor, a stator, an enclosure with a body and a cover for at least partially enclosing the rotor and the stator, electric cables connecting the motor forming a bundle of mutually independent cables, connected to the motor, said enclosure being provided with a housing for receiving a sleeve for retaining the bundle of cables formed in the cover or the body of the enclosure, this through cylindrical housing having an open end facing the inside of the enclosure and an open end facing the outside of the enclosure, characterized in that it comprises:
a step of moulding of the sleeve over the bundle of cables connected to the motor;
a step of insertion, through the open end facing the inside of the enclosure, of the sleeve into the housing;
a step of at least partial extraction of the sleeve out of the enclosure by pulling or pushing on the bundle of cables;
a step of fixing into relative position of the sleeve with respect to the enclosure by means of a fixing flange, itself fixed to the enclosure;
said fixing step being followed or preceded by a step of assembly of the cover and of the body.

According to one embodiment, the step of moulding of the sleeve over the bundle of cables is performed by overmoulding.

According to one embodiment, the method comprises:
after the step of extraction of the sleeve out of the enclosure by pulling or pushing on the bundle of cables and before the step of fixing into relative position of the sleeve with respect to the enclosure by means of a fixing flange, itself fixed to the enclosure,
a step of fitting on the sleeve of sealing O-ring seals threaded onto the bundle of cables, and
a step of insertion of the sleeve fitted with the O-ring seals, into the housing of the enclosure.

According to one embodiment, for the step of fitting, on the sleeve, of sealing O-ring seals, the sleeve comprises grooves for receiving the O-ring seals.

According to one embodiment, the step of insertion of the sleeve into the housing of the enclosure is a partial insertion of the sleeve, corresponding to the part of the sleeve bearing the sealing seals.

According to one embodiment, the step of fixing into relative position of the sleeve with respect to the cover is performed by cooperation of the fixing flange with a groove of the sleeve kept outside the housing during the step of insertion of the sleeve into the housing of the enclosure.

Also a subject of the invention is an electric motor comprising a rotor, a stator, an enclosure with a body and a cover for at least partially enclosing the rotor and the stator, electric cables connecting the motor forming a bundle of mutually independent cables, connected to the motor, said enclosure being provided with a housing for receiving a sleeve for retaining the bundle of cables formed in the cover or the body of the enclosure, this through cylindrical housing having an open end facing the inside of the enclosure and an open end facing the outside of the enclosure, characterized in that the sleeve is moulded over the bundle of cables connected to the motor and in that the sleeve is fixed in relative position with respect to the enclosure by means of a fixing flange, itself fixed to the enclosure.

According to one embodiment of the electric motor, said electric motor is obtained by the implementation of the method mentioned above.

Another subject of the invention is an automotive vehicle bearing at least one electric motor, characterized in that the electric motor is as mentioned above.

### BRIEF DESCRIPTION OF THE DRAWINGS

The invention will be well understood on reading the following description of exemplary embodiments, with reference to the attached drawings in which:

FIG. 1 represents an automotive vehicle for cutting grass, bearing at least one electric motor, according to the invention;

FIG. 2 represents a view in axial cross section of an electric motor during the fitting of the cover of the enclosure of the motor;

FIG. 3 represents a view in axial cross-section of an electric motor after the fitting of the sealing O-ring seals on the sleeve;

FIG. 4 represents a perspective view of the sleeve in front of the opening of the cover of the enclosure, according to FIG. 3;

FIG. 5 represents a perspective view of the sleeve of FIG. 4 before fitting of the fixing flange;

FIG. 6 represents a view in axial cross-section of the motor after fitting of the fixing flange;

FIG. 7 represents a perspective view of the sleeve and of the flange of FIG. 6;

FIG. 8 represents a perspective view of the enclosure of the electric motor after assembly according to the invention;

FIG. 9 represents another perspective view of the enclosure of the electric motor after assembly according to the invention.

### DETAIL DESCRIPTION OF EMBODIMENTS

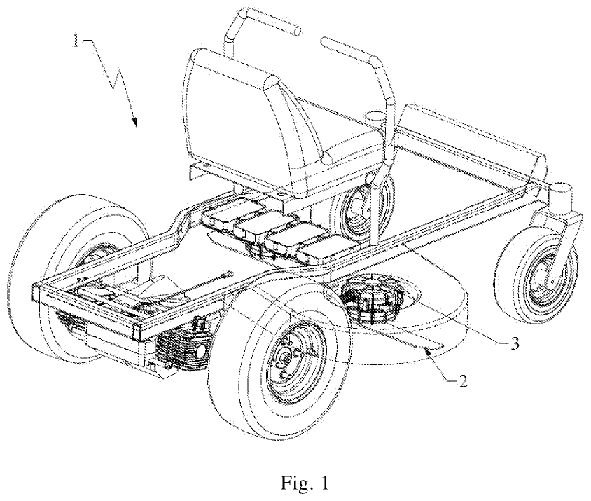

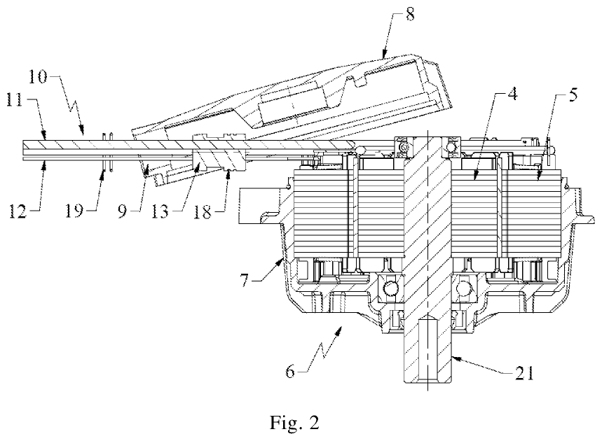

FIG. 1 symbolically represents an automotive vehicle 1 for cutting grass on a lawn or a space reserved for a sport practiced on grass, by means of cutting blades 2, driven by an electric motor 3. The motor 3 (FIG. 2) comprises a rotor 4, a stator 5, and an enclosure 6 composed of a body 7 and of a cover 8. The cover 8 comprises an opening into which the bundle 10 of cables runs. The bundle 10 of cables comprises, for example, power supply cables 11 for the stator 5 supplying three-phase current, and thinner cables 12, for linking to sensors housed in the enclosure 6 of the electric motor 3. The opening of the cover 8 constitutes a cylindrical housing 9, for receiving a sleeve 13 for retaining the bundle 10 of cables. This through cylindrical housing 9 has an open end facing the inside of the enclosure 6 and an open end facing the outside of the enclosure 6.

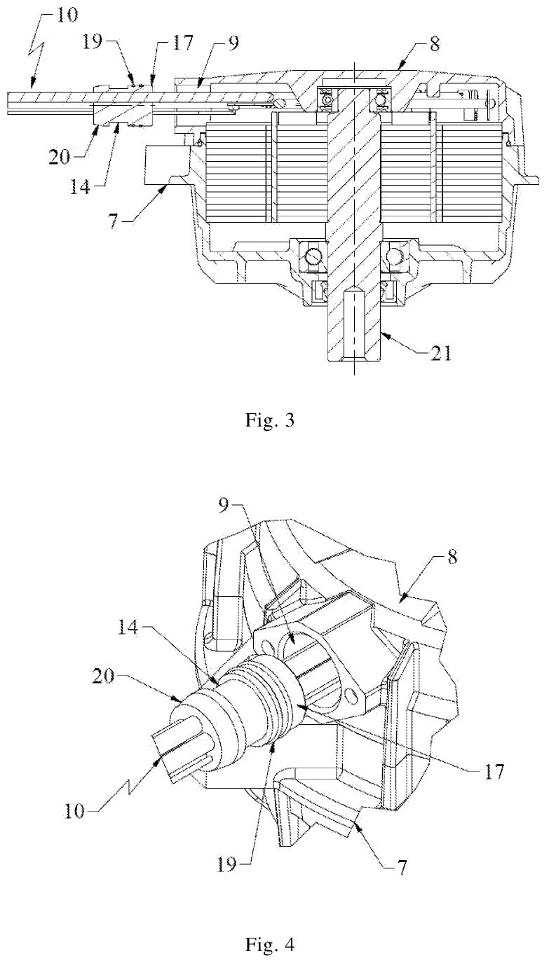

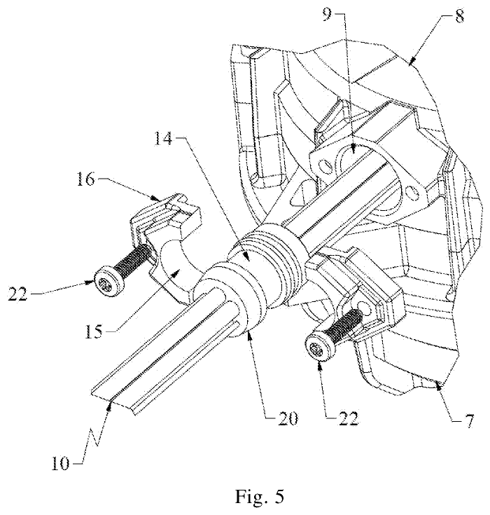

The sleeve 13 is of generally cylindrical form (FIG. 3). In its central part, it has a groove 14 intended to receive the bearing 15 of a flange 16 for fixing onto the cover 8 (FIG. 5). On one side of the groove 14, the sleeve 13 has a rear part 17 having two circular grooves 18 intended to receive sealing O-ring seals 19. On the other side of the groove 14, the sleeve 13 comprises a front part 20 that remains outside the flange 16.

The shaft 21 of the rotor 4 ensures the driving of the cutting blades 2.

The method for assembling the motor 3 preferably proceeds in six steps after the connection of the cables to the motor.

The first step is a step of moulding of the sleeve 13 over the bundle 10 of the cables already connected to the motor 3, in particular to the stator 5 of the motor 3. This step is performed by overmoulding, close to the body 7 of the enclosure 6 whose cover 8 is absent. During this overmoulding operation, each of the cables of the bundle 10 of cables is surrounded by the material of the sleeve 13, which remains secured to the cable. The cables are therefore insulated from one another by the material of the sleeve 13, and are individually retained by the sleeve 13 against any attempt to tear, whether deliberate or accidental.

The second step is a step of insertion, through the open end facing the inside of the enclosure 6, of the sleeve 13 into the housing 9 (FIG. 2). First of all, the inside of the housing 9 of the cover 8 is offered up in front of the free end of the bundle 10 of cables. The housing 9 is threaded onto the bundle 10 of cables and the cover 8 is displaced, by sliding, to the body 7, where it is in position of closure of the enclosure 6. During this displacement, the cover 8 drives the sleeve 13 which remains retained by the internal edge of the housing 9.

The third step is a step of extraction of the sleeve 13 out of the enclosure 6. This manual operation consists, by action on the bundle 10 of cables which is secured to the sleeve 13, in orienting the sleeve 13 in the axis of the housing 9. The front part 20 of the sleeve 13 has a frustoconical profile which facilitates its introduction into the housing 9. The outer diameter of the sleeve 13 is determined such that the sleeve 13 slides without effort into the housing 9.

A slight pull on the bundle 10 of cables is sufficient to bring, by sliding, the sleeve 13 out of the housing 9.

The fourth step is a step of fitting onto the sleeve 13 of sealing O-ring seals.

The O-ring seals 19 are threaded onto the bundle 10 of cables and fitted manually in the grooves 18 of the rear part 17 of the sleeve 13 (FIG. 3).

The fifth step is a step of insertion of the rear part 17 of the sleeve 13, bearing the sealing O-ring seals 19, into the housing 9 of the cover 8. Once this insertion has been done, the O-ring seals 19 ensure the watertightness and airtightness of the housing 9.

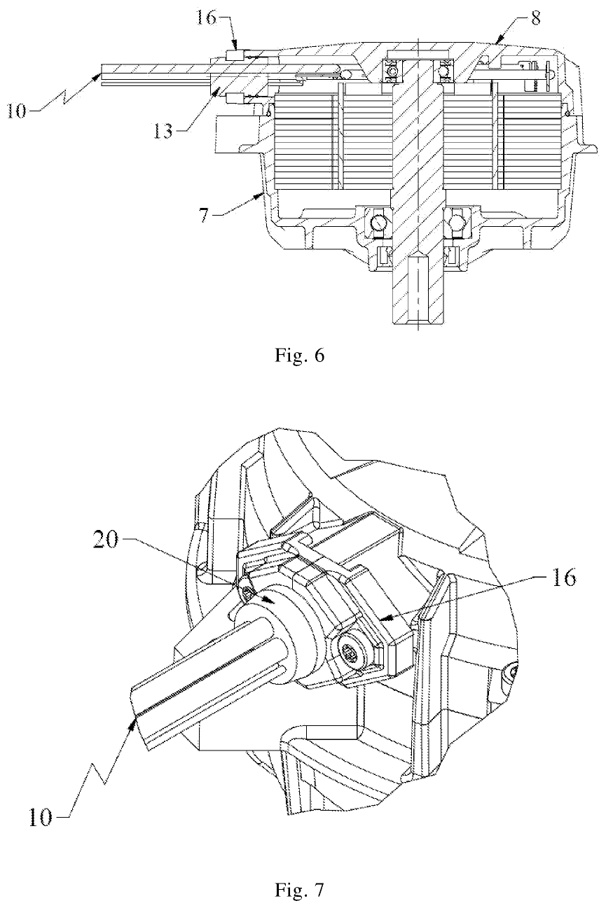

The sixth step is a step of fixing into relative position of the sleeve 13 with respect to the cover 8 by means of a flange 16 (FIG. 5). The bearing 15 of the flange 16 is applied in the groove 14 of the sleeve 13. The flange 16 is fixed by screws 22 onto the outer face of the cover 8, on either side of the housing 9. The flange 16 thus ensures the immobilizing of the sleeve 13 and of the bundle 10 of cables with respect to the enclosure 6 of the motor 3 (FIG. 6). At this stage, the assembly of the cover 8 and of the body 7 of the enclosure 6 by screwing can be performed.

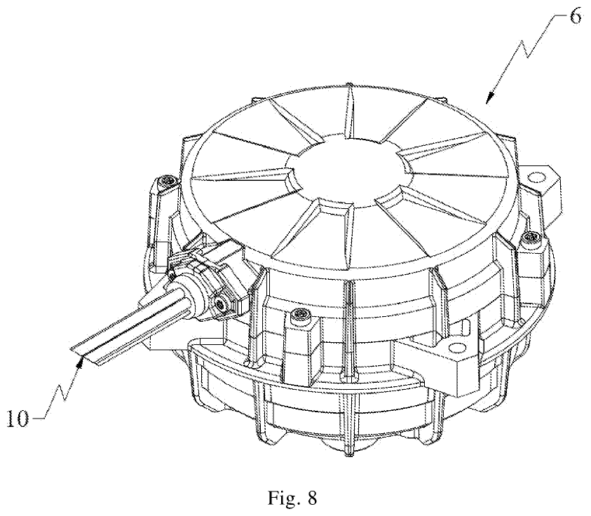

Once the assembly is finished, the electric motor 3 is in its enclosure 6 (FIG. 8), with the housing 9 closed by the sleeve 13 and the sealing O-ring seals 19. It should be noted that, conventionally, an O-ring seal is inserted between the cover and the body of the enclosure 6 and a seal is provided at the output shaft of the motor. The enclosure 6 is therefore watertight and airtight. The cables running in the sleeve 13 are immobilized therein by the overmoulding performed initially, which ensures the seal-tightness around each cable and ensures that each of the cables is held in position, which prevents any cable from being torn out.

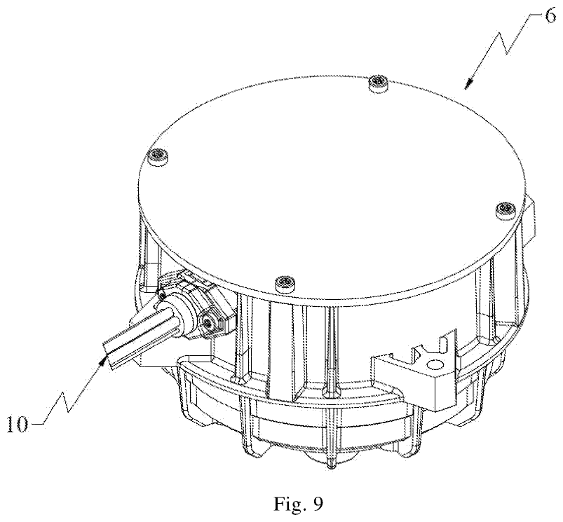

As a variant, the housing 9 can be formed in the body 7 of the enclosure 6 as illustrated in FIG. 9 (TO BE SUPPLIED BY THE INVENTOR). The assembly method is similar to that described above.

1. A method for assembling a motor having a rotor, a stator, an enclosure with a body and a cover for at least partially enclosing the rotor and the stator, electric cables for connecting the motor forming a bundle of mutually independent cables, connected to the motor, said enclosure being provided with a housing for receiving a sleeve for retaining the bundle of cables formed in the cover or the body of the enclosure, this through cylindrical housing having an open end facing the inside of the enclosure and an open end facing the outside of the enclosure, said method comprising the steps of:
a step of moulding of the sleeve over the bundle of cables connected to the motor;
a step of insertion through the open end facing the inside of the enclosure of the sleeve into the housing;
a step of at least partial extraction of the sleeve out of the enclosure by pulling or pushing on the bundle of cables;
a step of fixing into relative position of the sleeve with respect to the enclosure by means of a fixing flange, itself fixed to the enclosure; and
said fixing step being followed or preceded by a step of assembly of the cover and of the body.

2. The method according to claim 1, wherein the step of moulding of the sleeve over the bundle of cables is performed by overmoulding.

3. The method according to claim 1, wherein the method comprises:
after the step of extraction of the sleeve out of the enclosure by pulling or pushing on the bundle of cables and before the step of fixing into relative position of the sleeve with respect to the enclosure by means of a fixing flange, itself fixed to the enclosure,
a step of fitting onto the sleeve of sealing O-ring seals threaded onto the bundle of cables, and
a step of insertion of the sleeve fitted with the O-ring seals, into the housing of the enclosure.

4. The method according to claim 3, wherein, for the step of positioning, on the sleeve, of sealing O-ring seals, the sleeve comprises grooves for receiving the O-ring seals.

5. The method according to claim 3, wherein the step of insertion of the sleeve into the housing of the enclosure is a partial insertion of the sleeve, corresponding to the part of the sleeve bearing the sealing O-ring seals.

6. The method according to claim 1, wherein the step of fixing into relative position of the sleeve with respect to the enclosure is performed by cooperation of the fixing flange with a groove of the sleeve kept outside the housing during the step of insertion of the sleeve into the housing of the enclosure.

7. An electric motor comprising a rotor, a stator, an enclosure with a body and a cover for at least partially enclosing the rotor and the stator, electric cables for connecting the motor forming a bundle of mutually independent cables, connected to the motor, said enclosure being provided with a housing for receiving a sleeve for retaining the bundle of cables formed in the cover or the body of the enclosure, this through cylindrical housing having an open end facing the inside of the enclosure and an open end facing the outside of the enclosure, wherein the sleeve is moulded over the bundle of cables connected to the motor and in that the sleeve is fixed in relative position with respect to the enclosure by means of a fixing flange, itself fixed to the enclosure at the cover.

8. The electric motor according to claim 7, wherein the electric motor is obtained by the implementation of the method according to claim 1.

9. An automotive vehicle bearing at least one electric motor, wherein the electric motor conforms to one of claim 7.
